(19) United States
(12) Patent Application Publication
(10) Pub. No.: US 2021/0241579 A1
(43) Pub. Date: Aug. 5, 2021

(54) Method for Adaptive Slot Multiplier

(71) Applicant: Evolution Malta Limited, Sliema (MT)

(72) Inventor: Todd Haushalter, Gharghur (MT)

(21) Appl. No.: 17/165,377

(22) Filed: Feb. 2, 2021

(30) Foreign Application Priority Data
Feb. 3, 2020 (EP) 20155213.0

(51) Int. Cl. G07F 17/32; G07F 17/34

(52) U.S. Cl. CPC G07F 17/3267; G07F 17/34

(57) ABSTRACT

The present disclosure relates to a computer-implemented method for dynamic presentation of a slot multiplier in a live casino game, wherein said method comprises performing physical random number generation; capturing a video stream of said physical random number generation; performing secondary random number generation; determining a game state of said physical random number generation; and providing a graphical user interface comprising a visual representation of said video stream and said secondary random number generation, wherein said visual representation is dynamically adapted based on said determined game state.

### CROSS REFERENCE TO RELATED APPLICATIONS

This application claims priority to European Patent Application No. EP 20155213.0 filed Feb. 3, 2020, the disclosure of which is incorporated herein by reference in its entirety and for all purposes.

### FIELD OF THE INVENTION

The present inventive concept relates to a method for adaptive slot multiplier presentation in a live casino game.

### BACKGROUND OF THE INVENTION

Casino games such as roulette, carnival wheels, and slot machines are commonly found in casinos both online and local. The popularity of such machines is largely determined by the type of feedback they give to the players, in combination with the perceived likelihood of winning money at the machine. By improving the feedback that a given game provides to a player, the popularity of that game may be increased without adjusting the win-rate. For games with comparable or identical win-rates, players will turn to the game they find most interesting, exciting, and providing the most stimulating feedback. Therefore, developing means for providing more stimulating feedback is desirable.

### SUMMARY OF THE INVENTION

It is an object of the present inventive concept to alleviate at least some of the mentioned drawbacks of the prior art and to provide a method for dynamic presentation of a slot multiplier in a live casino game, and a corresponding (non-transitory) computer-readable storage medium. This and other objects, which will become apparent in the following, are accomplished by a method as defined in the accompanying independent claim.

The term exemplary should in this application be understood as serving as an example, instance or illustration.

The present inventive concept is at least partially based on the realization that combining the perceived authenticity of a live casino game with the tailor-made feedback design that is possible in online casino games will result in increased player satisfaction. This is beneficial, as this will increase player retention and also the likelihood of players choosing a game utilizing the method of the present inventive concept over other comparable games in the first place.

The present inventive concept is furthermore based on the realization that dynamically presenting a visual representation of a secondary random number generation, for example in the shape of a slot multiplier, allows for a dynamically variable weight to be given to this presentation. This means that the slot multiplier may be presented in such a way that the player is only encouraged to focus thereon during certain scenarios or game states. This helps a player focus on the important parts of the game, thus reducing the time it takes for a player to make decisions and absorb information presented on the device used to play.

The present inventive concept is furthermore based on the realization that giving the player the ability to customize the visual representation of given elements of a casino game will increase player attention, thus allowing information to be more efficiently conveyed. This allows for a faster game sequence, thus reducing total energy consumption per game, total bandwidth usage per game, and total time spent looking at the screen per game for a player. Since the captured video stream of the physical random number generation is continuously streamed to the player's local device, decreasing the time spent in a streaming mode is beneficial for the live casino provider, since this reduced the load on the bandwidth. Similar benefits are also found regarding total energy usage, including both the player's local device and the servers of the live casino. The health benefits of decreased screen time are many, and improving the rate at which the player may complete his or her game is therefore desirable.

According to the first aspect of the present inventive concept, a computer-implemented method for dynamic presentation of a slot multiplier in a live casino game is provided, wherein said method comprises: performing physical random number generation; capturing a video stream of said physical random number generation; performing secondary random number generation; determining a game state of said physical random number generation; providing a graphical user interface comprising a visual representation of said video stream and said secondary random number generation, wherein said visual representation is dynamically adapted based on said determined game state.

According to one example embodiment, the physical random number generation returns a value selected from a predetermined set of values. Said set of values include at least one value associated with a bonus game, and a plurality of different values on which a player may place their bet.

The secondary random number generation may either be a digital random number generation, a visual representation of which is overlaid onto the captured video stream when presented together with the graphical user interface. Alternatively, the secondary random number generation is a secondary physical random number generation, a video stream of which is captured and presented together with the captured video stream of the physical random number generation and the graphical user interface.

The secondary random number generation returns a value pair comprising one value chosen from the predetermined set of values of the physical random number generation, and one value chosen from a set of multiplier values.

The dynamic adaption of the presentation of the secondary random number generation allows for more efficient communication between the live casino and the player. This decreases bandwidth requirements, allows the player to make faster decisions, and reduces the risk of miscommunication.

According to one example embodiment, the method comprises accepting at least one bet from a player. The bets accepted are used to determine, for each player, which return values of the physical random number generation result in winnings being paid out to that player.

According to one example embodiment, the method further comprises providing a graphical user interface on a display of a remote electronic device, wherein the graphical user interface comprises detecting a user input indicative of a placed bet by a user of the remote electronic device, wherein the placed bet indicates a desired outcome of the physical random number generation.

According to one example embodiment, said method comprises updating the visual representation on the display based on the detected user input by modifying the visual representation so to emphasize the detected game state, the user input, and/or the return value pair of the secondary random number generation.

According to one example embodiment of the present inventive concept, said game state is determined based on a return value of said physical random number generation.

Said game state could be determined by means of comparing said return value and/or the rate of change of said return value with a set of instructions or conditions. For example, the return value of the physical random number generation may either be constant over a period of time, which indicates that the physical random number generation is in an inactive game state or an end state, or it could be changing over said period of time, which indicates that the physical random number generation is in a game in progress state.

In the embodiments where the secondary random number generation is a digital random number generation, connecting the output or return value of the physical random number generation with the determination of game state, is beneficial for the following reason. The visual representation of the secondary random number generation, which in this embodiment is virtual and artificial in nature, is coupled to the state of being of a physical entity, something which the player can view directly through the captured video stream. This increases a player's feeling of trust, thereby encouraging him or her to choose a game implementing the method of the present inventive concept over a game not implementing said method. The effect of this is that the provider of the game implementing the method of the present inventive concept needs to spend less time promoting the game and can therefore spend more time maintaining the game, thus increasing its stability.

According to one example embodiment of the present inventive concept, said step of determining a game state comprises comparing said return value of said physical random number generation with a set of game conditions.

This allows for the visual representation of the secondary random number generation to dynamically adapt to the currently determined game state. Also, from a maintenance and development perspective, comparing said return value with a set of game conditions allows this set of game conditions to be adapted, changed and improved in isolation from the rest of the components, modules and features of an implementation of the method of the present inventive concept, thereby reducing and confining the risk any such changes would bring.

According to one example embodiment of the present inventive concept, said return value is determined by means of image recognition.

By using image recognition software to determine the return value of the physical random number generation, alignment of the players' expectations and the returned value from the physical random number generation is achieved. In other words, what the players can see on the video stream that is transmitted to and presented on their local devices from the live casino is what is being evaluated by the image recognition software. This means that the captured video stream becomes the ground truth when determining the return value of the physical random number generation.

Additionally or alternatively, said return value is determined by means of photoelectric sensors, magnetometers, or mechanical counters. One benefit of using photoelectric sensors, magnetometers, or mechanical counters either in addition to or instead of image recognition software is that such solutions are reliable, robust and cheap. If used in combination with image recognition software, the output of the two sensing methods may be compared and a control unit may be configured to generate a warning or error message should any difference therebetween be detected.

According to one example embodiment of the present inventive concept, said step of determining a game state is performed by means of image recognition software applied to said captured video stream.

According to one example embodiment of the present inventive concept, said step of determining a game state comprises comparing a return value of said image recognition software with a set of game conditions.

According to one example embodiment of the present inventive concept, said set of game conditions comprises game conditions for an inactive game state, a game in progress state, and an end state.

For example, the inactive game state signifies that a game has yet to be started, and that the physical random number generation is at a steady state. Said steady state may either be a state of constant motion, or a non-moving state.

Furthermore, the game in progress state signifies that physical random number generation is in progress. This could for example mean that a means for physical random number generation is coming to a rest. The game in progress state is a transitional state.

Furthermore, the end state signifies that a game has been completed, and that the physical random number generation is at a steady state, for example a non-moving state. In this state, the return value of the physical random number generation may be compared with a set of game conditions in order to further determine which sub-state said physical random number generation is in.

According to one example embodiment of the present inventive concept, said end state comprises at least one win sub-state, at least one multiplied sub-state, and at least one bonus game sub-state.

Additionally or alternatively, said end state may comprise at least one loss sub-state. The loss sub-state may for example be the states on which no bets have been accepted for a given player.

The distribution of the multiplied sub-states in relation to the other sub-states of the physical random number generation may be determined by the return value pair of the secondary random number generation. The distribution of the win sub-states in relation to the other sub-states of the physical random number generation may be determined by bets placed by the player. If the determined game state of the physical random number generation is a win sub-state, i.e. the physical random number generation returns a value that corresponds to a bet placed by a player, winnings are paid out to that player's account. If the determined game state of the physical random number generation is simultaneously a win sub-state and a multiplied sub-state, i.e. the physical random number generation returns a value that corresponds to a bet placed by a player and the secondary random number generation returns a multiplier for the value on which that player has placed his or her bet, then multiplied winnings are paid out to that player's account.

The determined sub-state of the physical random number generation, when in said end state, dynamically adapts the presentation of said visual representation of said secondary random number generation.

For example, if the physical random number generation is determined to be in the win sub-state, the visual representation of the secondary random number generation may be highlighted, enlarged, or moved to have a player's attention drawn thereto.

Furthermore, if the physical random number generation is determined to be in the bonus game sub-state, a bonus game module may be activated. This bonus game module comprises instructions for adapting the presentation of the visual representation of the secondary random number generation, and a set of game conditions for the bonus game that is to be initiated. A bonus game is a game in which the normal conditions of the physical random number generation do not apply. Instead, a special set of rules apply to the bonus game, often in a way so that the player's actual and/or perceived chance of winning is increased. The special set of rules applying to the bonus game may for example include additional rounds of secondary random number generation, accepting input from a player, and adapting the visual representation of the additional rounds of secondary random number generation based in the accepted input from said player.

Furthermore, if the physical random number generation is determined to be in the loss sub-state, the visual representation of the secondary random number generation may be temporarily obscured from a player's view, so as to draw that player's attention towards the next game and the bets that are to be placed thereon instead of towards the visual representation of the multiplier that was lost.

According to one example embodiment of the present inventive concept, said secondary random number generation moves between an inactive state, a multiplier randomization in progress state, and a multiplier return state.

According to one exemplary embodiment, the determined game state is used as a trigger for moving the secondary random number generation between these states. This allows the visual representation of the secondary random number generation to dynamically adapt to events for the physical random number generation.

According to one example embodiment of the present inventive concept, said secondary random number generation moves from an inactive state to a multiplier randomization in progress state when the determined game state changes from the inactive game state to the game in progress state.

According to one example embodiment of the present inventive concept, said secondary random number generation moves from a multiplier randomization in progress state to a multiplier return state before the determined game state changes from the game in progress state to the end state.

According to one example embodiment of the present inventive concept, said method further comprises estimating the time remaining until said physical random number generation moves from the game in progress state to the end state.

According to one example embodiment, the visual representation is dynamically adapted to highlight the return value pair of the secondary random number generation when the secondary random number generation moves to the multiplier return state, after which the visual representation is dynamically adapted to highlight the return value of the physical random number generation. This allows a player to first view the return value pair of the secondary random number generation, i.e. the slot multiplier, before the physical random number generation moves to the end state. This allows a player to more quickly make decisions on how to proceed with the game and where to focus his or her attention.

According to one example embodiment of the present inventive concept, said method further comprises providing means for physical random number generation, wherein said step of performing physical random number generation comprises imparting kinetic energy to said means for physical random number generation.

Said kinetic energy may for example be provided by causing said means for physical random number generation to spin, or by throwing said means for physical random number generation with a velocity that is at least partially randomized.

According to one example embodiment of the present inventive concept, said step of performing physical random number generation further comprises waiting until said means for physical random number generation comes to a rest.

According to one example embodiment of the present inventive concept, said method further comprises determining, by means of image analysis, photoelectric sensors, and/or magnetometers, the kinetic energy, inertial parameters, velocity, and/or position of the means for physical random number generation in order to estimate the time remaining until said physical random number generation moves from the game in progress state to the end state.

According to one example embodiment of the present inventive concept, said means for physical random number generation include roulette wheels, vertical roulette wheels, dice, and slot machines.

In this context, the return value of the physical random number generation and the secondary random number generation should be interpreted to also include abstract symbols. For example, sets of symbols or dice having colors or symbols instead of numbers are also to be interpreted as being valid return values of the physical random number generation.

According to another aspect of the present inventive concept, there is provided a According to another aspect of the present disclosure, there is provided a (non-transitory) computer-readable storage medium storing one or more programs configured to be executed by one or more processors of a processing system, the one or more programs comprising instructions for performing the method according to any one of the embodiments disclosed herein. With this aspect of the disclosure, similar advantages and preferred features are present as in the previously discussed aspects of the disclosure.

The term “non-transitory,” as used herein, is intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

Generally, all terms used in the description are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

These and other features and advantages of the present inventive concept will now be further clarified and described in more detail, with reference to the appended drawings showing different embodiments of a method according to the present inventive concept.

FIG. 1 is a diagrammatic representation of a graphical user interface, comprising a video stream of a live casino game utilizing the method of the present inventive concept,

FIG. 2a is a diagrammatic representation of a video stream of a live casino game utilizing the method of the present inventive concept, wherein the physical random number generation is in the inactive game state, and the secondary random number generation is in the inactive state,

FIG. 2b is another view of the diagrammatic visual representation of FIG. 2a, wherein the live casino game has been initiated and the visual representation has been dynamically adapted based on a determined game state,

FIG. 2c is another view of the diagrammatic visual representation of FIG. 2a, wherein the slot multiplier has entered the multiplier return state and returned a return value pair,

FIG. 2d is another view of the diagrammatic visual representation of FIG. 2a, wherein the vertical roulette wheel has entered its end state,

FIG. 3a is a diagrammatic representation of a video stream of a live casino game utilizing the method of the present inventive concept, wherein the physical random number generation is in the inactive game state, and the secondary random number generation is in the inactive state,

FIG. 3b is another view of the diagrammatic visual representation of FIG. 3a, wherein the live casino game has been initiated and the visual representation has been dynamically adapted based on a determined game state,

FIG. 3c is another view of the diagrammatic visual representation of FIG. 3a, wherein the slot multiplier has entered the multiplier return state and returned a return value pair,

FIG. 3d is another view of the diagrammatic visual representation of FIG. 3a, wherein the vertical roulette wheel has entered its end state and the visual representation has been dynamically adapted based on a determined game state,

FIG. 4 is a schematic illustration of how a live casino implementing the method of the present invention communicates with players' local clients,

FIG. 5 is a schematic illustration of the method of the present inventive concept.

### DETAILED DESCRIPTION OF EMBODIMENTS

In the following detailed description, some embodiments of the present inventive concept will be described. However, it is to be understood that features of the different embodiments are exchangeable between the embodiments and may be combined in different ways, unless anything else is specifically indicated. Even though in the following description, numerous specific details are set forth to provide a more thorough understanding of the present inventive concept, it will be apparent to one skilled in the art that the present inventive concept may be practiced without these specific details. In other instances, well known constructions or functions are not described in detail, so as not to obscure the present inventive concept.

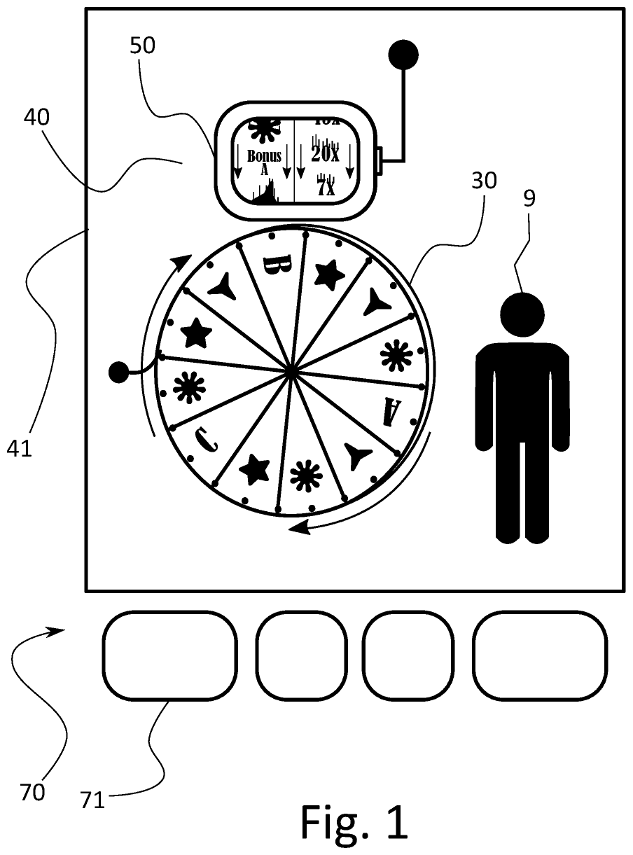

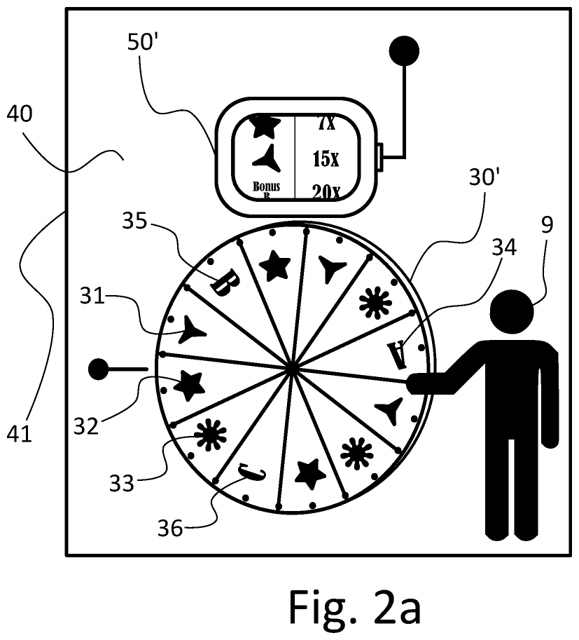

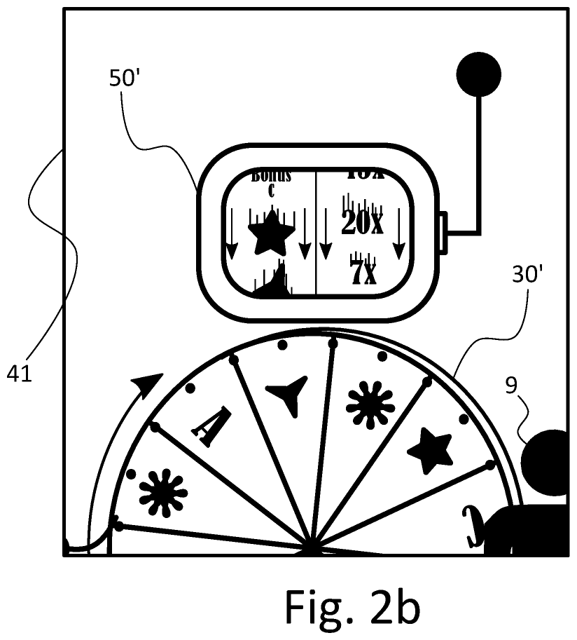

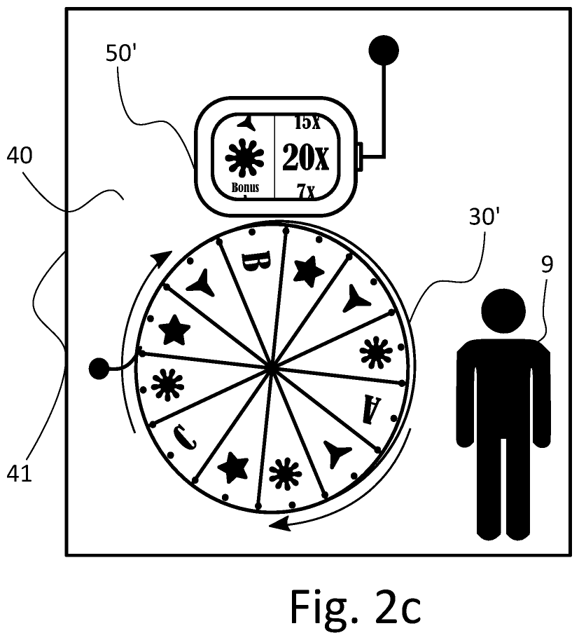

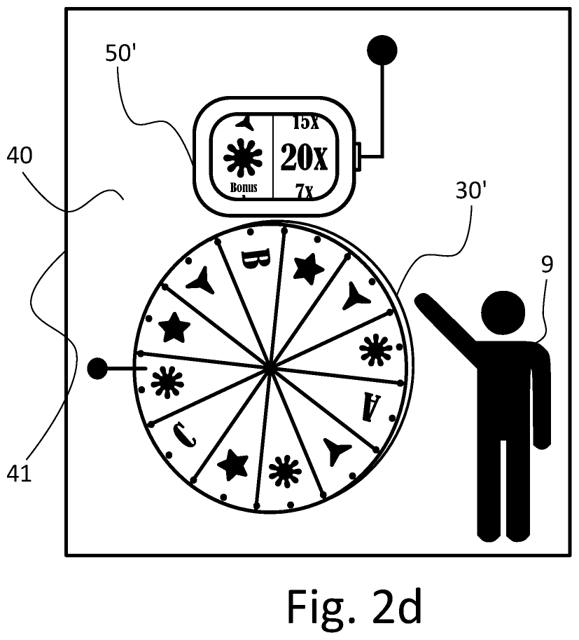

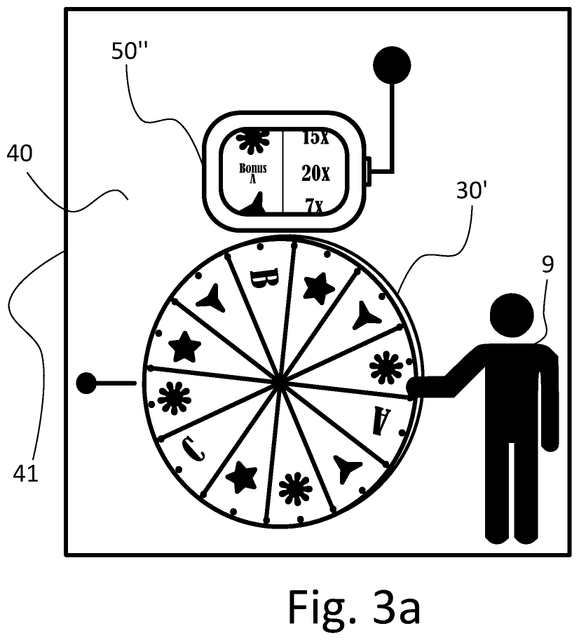

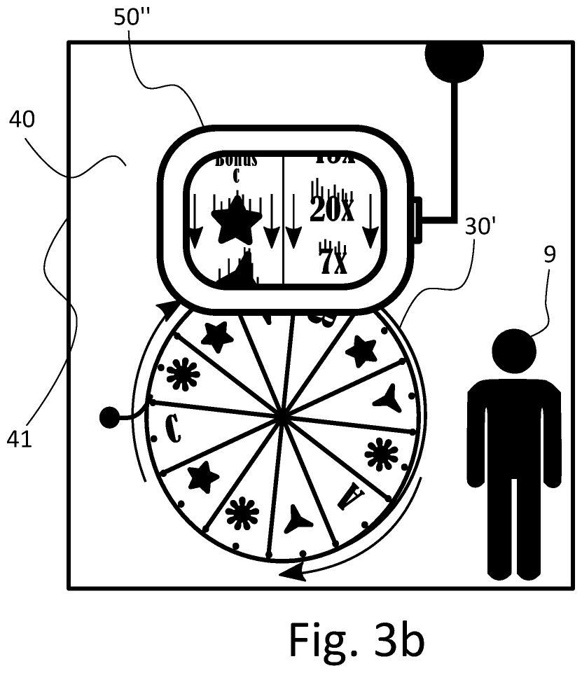

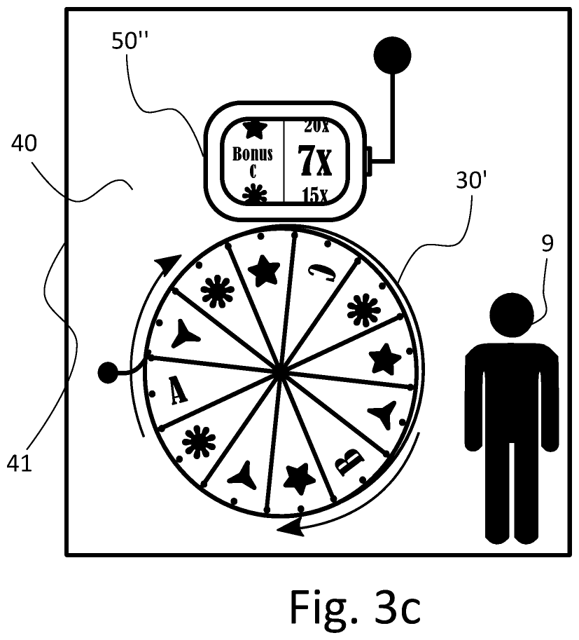

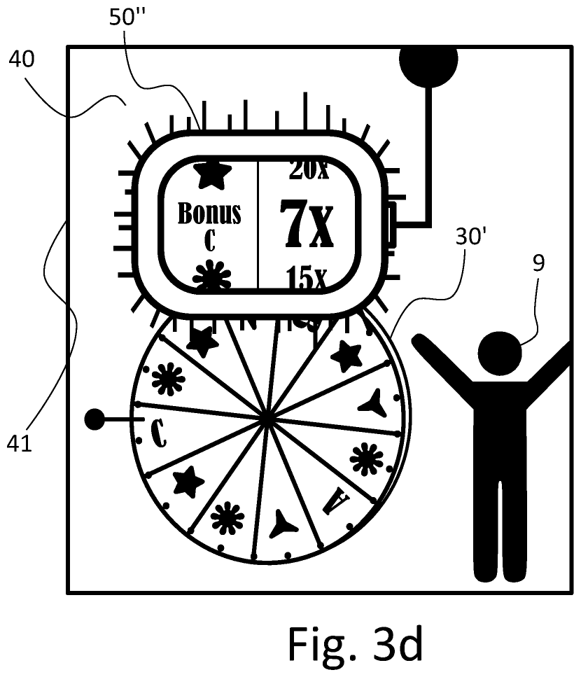

FIG. 1 is a diagrammatic visual representation of a graphical user interface 70, comprising a video stream 40 of a live casino game having means 30 for physical random number generation 3, wherein the live casino game utilizes the method 1 of the present inventive concept. The graphical user interface 70 includes fields 71 used to accept input from a player, and to present information about winnings, game state, account balance, time, and other parameters to the player. The video stream 40 also include means 50 for secondary random number generation 5 that is performed in response to the physical random number generation 3 of the live casino game entering certain game states. This will be discussed in more detail in relation to FIGS. 2a-3d.

FIG. 2a is a diagrammatic visual representation 41 of a video stream 40 of a live casino game utilizing the method 1 of the present inventive concept, wherein the physical random number generation 3 is in the inactive game state, and the secondary random number generation 5 is in the inactive state. The live casino game comprises means 30 for physical random number generation 3 in the shape of a vertical roulette wheel 30′ configured to rotate about its midpoint, thereby randomly selecting one of a number of return values. The return values of the physical random number generation 3 which is illustrated in FIG. 2 include a first symbol 31, a second symbol 32, a third symbol 33, Bonus A 34, Bonus B 35, and Bonus C 36. The return values of the value pair of the secondary random number generation 5 include a first symbol 31, a second symbol 32, a third symbol 33, Bonus A 34, Bonus B 35, and Bonus C 36 for the first value, and a multiplier value of 7×, 15×, or 20× for the second value of the value pair. As is readily understood by the skilled person, other or additional values may be included in the sets of valid return values for the random number generation steps 3, 5 discussed herein.

FIG. 2b is another view of the diagrammatic visual representation 41 of FIG. 2a, wherein the live casino game has been initiated. The vertical roulette wheel 30′ has been caused to rotate, either by a game host 9 or by a control unit 83 of the live casino 80 signaling a motor or actuator to give the vertical roulette wheel 30′ a rotational speed randomly chosen from a range of permitted rotational speeds. Once rotating, the game state is determined 6, for example by means of image recognition software of by means of sensors connected to the vertical roulette wheel 30′, to be in a game in progress state. As the determined game state moves from an inactive game state to a game in progress state, the secondary random number generation 5, herein enabled by means of a slot machine or a slot multiplier 50′, moves from its inactive state to its multiplier randomization in progress state.

When both the vertical roulette wheel 30′ and the slot multiplier 50′ is in a state of random number generation 3, 5, the visual representation 41 of the video stream 40 is dynamically adapted 8 based on said determined game state. Here, the determination that the slot multiplier 50′ is in the multiplier randomization in progress state results in the visual representation 41 focusing on the slot multiplier 50′, zooming in thereon to cause the player to focus on that part of the game. As the slot multiplier 50′ moves closer to its multiplier return state, more weight is given to the slot multiplier 50′ in the visual representation 41 of the video stream 40. As such, the player will be entirely focused on the slot multiplier 50′ when this returns a return value.

FIG. 2c is another view of the diagrammatic visual representation 41 of FIG. 2a, wherein the slot multiplier 50′ has entered the multiplier return state and returned a return value pair. The vertical roulette wheel 30′ is in the game in progress state, so the visual representation 41 of the video stream 40 is dynamically adapted 8 to put less weight on the slot multiplier 50′, which has already been returned, and more weight on the vertical roulette wheel 30′, which moves towards its end state.

FIG. 2d is another view of the diagrammatic visual representation 41 of FIG. 2a, wherein the vertical roulette wheel 30′ has entered its end state. Since the return value of the vertical roulette wheel 30′ corresponds to one member of the value pair returned by the slot multiplier 50′, the determined end state is a multiplied sub-state. Should the return value of the vertical roulette wheel 30′ also correspond to a bet accepted from a given player, the determined end state would be a multiplied win sub-state, and multiplied winnings would be paid out to that player.

FIGS. 3a-3d are diagrammatic visual representations 41 of a video stream 40 of a live casino game utilizing the method 1 of the present inventive concept, wherein the secondary random number generation 5 is a digital random number generation or a digital slot multiplier, and the visual representation 50″ thereof is overlaid onto the visual representation 41 of the video stream 40. As in FIGS. 2a-2d, the vertical roulette wheel 30′ moves from an inactive game state to a game in progress state. The digital random number generation 5, herein presented as a visual representation 50″ of a digital random number generation or a digital slot multiplier, moves from an inactive state to a multiplier randomization in progress state. As it does so, the visual representation 50″ of the digital slot multiplier is dynamically adapted 8 and positioned such that a player's attention is focused thereon. The visual representation 50″ of the digital slot multiplier is enlarged, moved and given more weight in the visual representation 41 that is presented as part of the graphical user interface 70 seen by the player. Once a value pair has been returned by the digital slot multiplier, the visual representation 41 is dynamically adapted 8 once again to put less weight on the visual representation 50″ of the digital slot multiplier, and more weight on the vertical roulette wheel 30′ as this moves from a game in progress state to an end state. In FIG. 3c, the digital slot multiplier has returned a value pair of Bonus C and 7×.

In FIG. 3d, the vertical roulette wheel 30′ has entered its end state. Since the return value of the vertical roulette wheel 30′ corresponds to the first value of the value pair returned by the slot multiplier, the determined end state is a multiplied sub-state. Furthermore, since the return value of the vertical roulette wheel 30′ corresponds to a bonus game, the determined end state is a multiplied bonus game sub-state. By entering the multiplied bonus game sub-state, a bonus game module may be activated, thereby initiating a bonus game, the winnings from which will be multiplied by the multiplier value returned by the digital slot multiplier. In FIG. 3d, the visual representation 50″ of the digital slot multiplier is again dynamically adapted 8 and positioned such that a player's attention is focused thereon. The visual representation 50″ of the digital slot multiplier is enlarged, moved, highlighted and given more weight in the visual representation 41 that is presented as part of the graphical user interface 70 seen by the player.

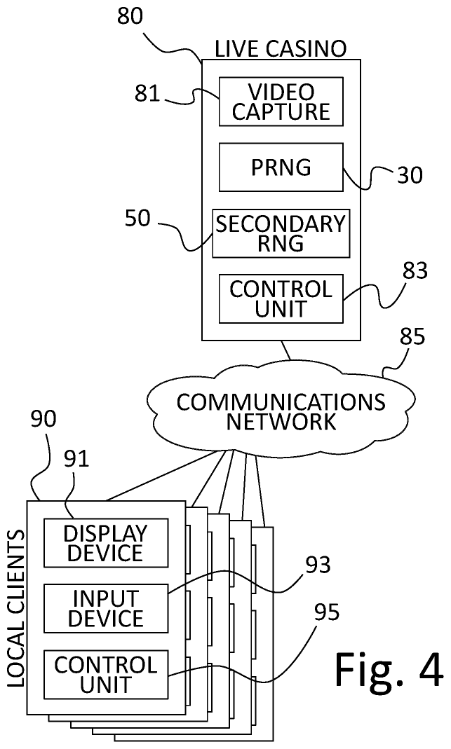

FIG. 4 is a schematic illustration of how a live casino 80 implementing the method 1 of the present invention communicates with players' local clients 90. This figure shows how the live casino 80 comprises means for video capture 81, physical random number generation (PRNG) 30, secondary random number generation (secondary RNG) 50, and a control unit 83 configured to implement the method 1 of the present inventive concept. After capturing 4 a video stream 40 of the physical random number generation 3 and the secondary random number generation 5, this video stream 40 is integrated into a graphical user interface 70 presented to players through use of a communications network 85. At the local client 90 of a player, the graphical user interface 70 is displayed on a display device 91, and integrated with through means of an input device 93. A control unit 95 of the local client 90 then communicates with the control unit 83 of the live casino 80, thereby allowing the player to place bets and otherwise interact with the live casino game in progress. The dynamic adaptation 8 of the visual representation 41 that is provided with the graphical user interface 70 is done in the control unit 83 of the live casino 80. In an alternative embodiment, this dynamic adaptation 8 of the visual representation 41 is done in the control unit 95 of the local client 90.

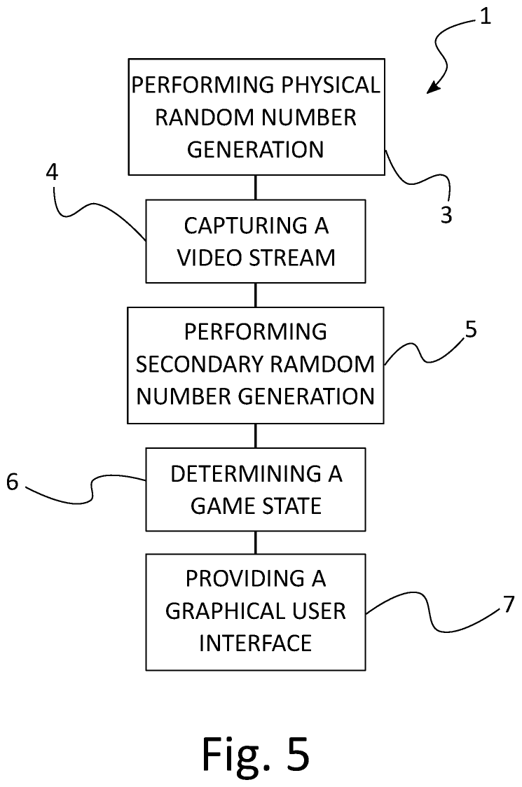

FIG. 5 is a schematic illustration of the method 1 of the present inventive concept. The method comprises performing physical random number generation 3, for example by means of a vertical roulette wheel 30′ as illustrated in FIGS. 1-3d. The physical random number generation 3 moves through an inactive game state, a game in progress state, and an end state. The end state comprises win at least one sub-state, at least one multiplied sub-state, and least one bonus game sub-state. The physical random number generation returns a value chosen from a predetermined set of return values. The method further comprises capturing 4 a video stream 40 of the physical random number generation 3. Furthermore, the method comprises performing secondary random number generation 5, for example by means of a slot multiplier 50′ or a digital slot multiplier 50″. The secondary random number generation 5 moves through an inactive state, a multiplier randomization state, and a multiplier return state. The secondary random number generation 5 returns a value pair, the first value of which is chosen from the predetermined set of return values of the physical random number generation 3, and the second value of which is a numerical value chosen from a set of multiplier values. The captured video stream 40 may also comprise, in certain embodiments of the present inventive concept, the secondary random number generation 5 or a visual representation 51 of the secondary random number generation 5. The method further comprises determining a game state 6 of the physical random number generation 3, for example by means of image recognition software or sensors connected to the means 30 for physical random number generation 3. The determined game state is used as input for controlling the movement between states for the physical random number generation 3 and the secondary random number generation 5. The method comprises providing 7 a graphical user interface 70 to a player, wherein the graphical user interface 70 comprises a visual representation 41 of the video stream 40, including the physical random number generation 3 and the secondary random number generation 5. Finally, the method comprises dynamically adapting 8 the visual representation 41 based on the determined game state, as is described in relation to FIGS. 2a-3d.

The person skilled in the art realizes that the present inventive concept by no means is limited to the embodiments described above. The features of the described embodiments may be combined in different ways, and many modifications and variations are possible within the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements. The steps of the method of the present inventive concept are not necessarily performed in the order listed above. For example, the steps of determining a game state and capturing a video stream may be performed continuously throughout a game sequence.

1. A computer-implemented method for dynamic presentation of a slot multiplier in a live casino game, wherein said method comprises
performing physical random number generation;
capturing a video stream of said physical random number generation;
performing secondary random number generation;
determining a game state of said physical random number generation;
providing a graphical user interface comprising a visual representation of said video stream and said secondary random number generation, wherein said visual representation is dynamically adapted based on said determined game state.

2. A method according to claim 1, wherein said step of determining a game state comprises comparing a return value of said physical random number generation with a set of game conditions.

3. A method according to claim 1, wherein said step of determining a game state is performed by means of image recognition software applied to said captured video stream.

4. A method according to claim 2, wherein said set of game conditions comprises game conditions for an inactive game state, a game in progress state, and an end state.

5. A method according to claim 4, wherein said end state comprises at least one win sub-state, at least one multiplied sub-state, and at least one bonus game sub-state.

6. A method according to claim 1, wherein the secondary random number generation returns a value pair comprising one value chosen from a predetermined set of values that said physical random number generation may return, and one value chosen from a set of multiplier values.

7. A method according to claim 1, wherein said secondary random number generation moves between an inactive state, a multiplier randomization in progress state, and a multiplier return state.

8. A method according to claim 4, wherein said secondary random number generation moves from an inactive state to a multiplier randomization in progress state when the determined game state changes from the inactive game state to the game in progress state.

9. A method according to claim 8, wherein said secondary random number generation moves from the multiplier randomization in progress state to a multiplier return state when the determined game state changes from the game in progress state to the end state.

10. A method according to claim 4, wherein said method further comprises
estimating the time remaining until said physical random number generation moves from the game in progress state to the end state.

11. A method according to claim 1, wherein said method further comprises
providing means for physical random number generation, wherein said step of performing physical random number generation comprises imparting kinetic energy to said means for physical random number generation.

12. A method according to claim 11, wherein said step of performing physical random number generation further comprises waiting until said means for physical random number generation comes to a rest.

13. A method according to claim 12, wherein said means for physical random number generation include roulette wheels, vertical roulette wheels, dice, and slot machines.

14. A computer-readable storage medium storing one or more programs configured to be executed by one or more processors of a processing system, the one or more programs comprising instructions for performing the method according to claim 1.
